(19) United States
(12) Patent Application Publication
(10) Pub. No.: US 2015/0220212 A1
(43) Pub. Date: Aug. 6, 2015

(54) DISPLAY DEVICE

(71) Applicant: SAMSUNG DISPLAY CO., LTD., Yongin-City (KR)

(72) Inventor: Jinhwan Kim, Suwon-si (KR)

(21) Appl. No.: 14/609,760

(22) Filed: Jan. 30, 2015

(30) Foreign Application Priority Data
Feb. 3, 2014 (KR) 10-2014-0012187

(51) Int. Cl. G06F 3/042; G02F 1/1333

(52) U.S. Cl. CPC G06F 3/0421; G02F 1/13338

(57) ABSTRACT

A display device that includes: a light source that emits a visible light and a detection light having a wavelength range different from a wavelength range of the visible light; an optical member disposed on the light source; a display panel disposed on the optical member and including a pixel configured to receive the visible light to generate an image; a liquid crystal lens that includes a liquid crystal layer and first electrodes, wherein the first electrodes form a first lens unit, the first lens unit having a first focal point located in the optical member to condense the detection light exiting from the display panel to an input device disposed outside the display panel; and a light sensor that receives the detection light reflected by the input device to sense an external input.

### CROSS-REFERENCE TO RELATED APPLICATION

This U.S. non-provisional patent application claims priority under 35 U.S.C. §119 to Korean Patent Application No. 10-2014-0012187, filed on Feb. 3, 2014, the disclosure of which is incorporated by reference herein in its entirety.

### TECHNICAL FIELD

The present invention relates to a display device. More particularly, the present invention relates to a display device capable of increasing a light sensing sensitivity.

### DISCUSSION OF THE RELATED ART

Various input devices, e.g., a touch panel, a light sensor, etc., have been developed for a display device to replace an input device, such as a keyboard, a mouse, a remote controller, etc.

The light sensor senses an external input that makes contact with the display device or comes close to the display device. When the external input is not close to the display device, the light sensor does not sense the external input. In other words, long distance external inputs are not sensed by the light sensor.

### SUMMARY

An exemplary embodiment of the present invention provides a display device including a light source that emits a visible light and a detection light having a wavelength range different from a wavelength range of the visible light; an optical member disposed on the light source; a display panel disposed on the optical member and including a pixel configured to receive the visible light to generate an image; a liquid crystal lens that includes a liquid crystal layer and first electrodes, wherein the first electrodes form a first lens unit, the first lens unit having a first focal point located in the optical member to condense the detection light exiting from the display panel to an input device disposed outside the display panel; and a light sensor that receives the detection light reflected by the input device to sense an external input.

The first lens unit has a numerical aperture of about 0.3 or more and the numerical aperture satisfies the following equation, NA=sin(θ_{T}), where θ_{T} is a maximum incident angle of the first lens unit and is smaller than about 90 degrees, and NA denotes the numerical aperture.

The first lens unit has a width and a first focal length, and the width and the first focal length satisfy the following equation, W/2K=tan(θ_{T}), where W denotes the width and K denotes the first focal length.

The optical member includes a prism sheet and a diffusion sheet disposed on the prism sheet, and the first focal point is located on a diffusion surface of the diffusion sheet.

The liquid crystal lens further includes second electrodes that form a second lens unit having a second focal point located in the pixel.

The first electrodes are spaced apart from the second electrodes and the liquid crystal layer is disposed between the first electrodes and the second electrodes.

The pixel includes a liquid crystal capacitor, a thin film transistor that applies a pixel voltage to the liquid crystal capacitor, and a color filter overlapped with the liquid crystal capacitor.

The second focal point is located in the color filter.

Each of the first and second lens units is a Fresnel zone plate lens.

The light sensor includes a photo-transistor configured to generate a photocurrent corresponding to an amount of the received detection light.

An exemplary embodiment of the present invention provides a display device including: a light source that emits a visible light in display periods and an infrared light in detection periods; an optical member disposed on the light source; a display panel disposed on the optical member and configured to generate a two-dimensional image in a two-dimensional mode display period of the display periods and a three-dimensional image in a three-dimensional mode display period of the display periods; a light sensor disposed on the optical member and configured to receive a portion of the infrared light reflected by an input device to sense an external input; and a liquid crystal lens that includes a liquid crystal layer, first electrodes and second electrodes, wherein the first electrodes form a first lens unit having a first focal point located in the optical member, and the second electrodes form a second lens unit having a second focal point located in the display panel.

The first electrodes are spaced apart from the second electrodes and the liquid crystal layer is disposed between the first electrodes and the second electrodes.

The first electrodes have a same electric potential as the second electrodes during the two-dimensional mode display period.

The optical member includes a prism sheet and a diffusion sheet disposed on the prism sheet, and the first focal point is located on a diffusion surface of the diffusion sheet.

The display panel includes: a first substrate; a second substrate spaced apart from the first substrate; and a plurality of pixels disposed between the first and second substrates, and at least one of the pixels includes: a liquid crystal capacitor; a thin. film transistor that applies a pixel voltage to the liquid crystal capacitor; and a color filter overlapped with the liquid crystal capacitor.

The second focal point is located in the color filter.

The light sensor includes a photo-transistor configured to generate a photocurrent corresponding to an amount of the received detection light.

The photo-transistor is disposed on the first substrate.

Each of the first and second lens units is a Fresnel zone plate lens.

The first lens unit has a numerical aperture of about 0.3 or more and the numerical aperture satisfies the following equation, NA=sin(θ_{T}), where θ_{T} is a maximum incident angle of the first lens unit and is smaller than about 90 degrees, and NA denotes the numerical aperture.

An exemplary embodiment of the present invention provides a display device that includes: a first light emitting device configured to emit visible light during a display period; a second light emitting device configured to emit infrared light during a detection period; an optical member configured to emit the infrared light from the second light emitting device, the optical member including a diffusion sheet; a first lens unit that includes a plurality of electrodes, the first lens unit configured to condense the infrared light emitted from the optical member, the first lens unit having a first inner focal point located in the diffusion sheet; and a display panel disposed between the first lens unit and the optical member, the display panel including a light sensor configured to sense a non-touch input.

The first lens unit has a numerical aperture NA of about 0.3 or more, the numerical aperture satisfies the following equation, NA=sin(θ_{T}), where θ_{T} is a maximum incident angle of the first lens unit and is smaller than about 90 degrees, and NA denotes the numerical aperture.

The display device further includes a second lens unit that includes a plurality of electrodes, the second lens unit having a second inner focal point located on a pixel of the display panel.

### BRIEF DESCRIPTION OF THE DRAWINGS

The above and other features of the present invention will become more apparent by describing in detail exemplary embodiments thereof with reference to the accompanying drawings, wherein:

FIG. 1 is an exploded perspective view showing a display device according to an exemplary embodiment of the present invention;

FIG. 2 is a block diagram showing a display device according to an exemplary embodiment of the present invention;

FIG. 3A is an equivalent circuit diagram showing a pixel according to an exemplary embodiment of the present invention;

FIG. 3B is an equivalent circuit diagram showing a light sensor according to an exemplary embodiment of the present invention;

FIG. 4 is a perspective view showing a portion of a display panel according to an exemplary embodiment of the present invention;

FIG. 5 is a cross-sectional view taken along a line I-I′ shown in FIG. 4, according to an exemplary embodiment of the present invention;

FIG. 6 is a side view showing a backlight unit according to an exemplary embodiment of the present invention;

FIG. 7 is a cross-sectional view showing a liquid crystal lens according to an exemplary embodiment of the present invention;

FIG. 8 is an enlarged cross-sectional view showing a liquid crystal lens according to an exemplary embodiment of the present invention;

FIG. 9 is a cross-sectional view showing a portion of a first lens unit, according to an exemplary embodiment of the present invention;

FIG. 10 is a graph showing voltages applied to electrodes that form a first lens unit, according to an exemplary embodiment of the present invention;

FIG. 11 is a graph showing a phase distribution of a portion of a first lens unit, according to an exemplary embodiment of the present invention;

FIG. 12A is a graph showing a phase distribution of a first lens unit, according to an exemplary embodiment of the present invention;

FIG. 12B is a graph showing a phase distribution of a second lens unit, according to an exemplary embodiment of the present invention;

FIG. 13 is a timing diagram showing signals generated in a two-dimensional mode display device according to an exemplary embodiment of the present invention;

FIG. 14A is a cross-sectional view showing a display device operated in a display period of the two-dimensional mode, according to an exemplary embodiment of the present invention;

FIG. 14B is a cross-sectional view showing a display device operated in a detection period of the two-dimensional mode, according to an exemplary embodiment of the present invention;

FIG. 15A is a view showing a path of an infrared light output from a display device according to a comparative example;

FIG. 15B is a graph showing a light detection efficiency of the display device shown in FIG. 15A;

FIG. 16A is a view showing a path of an infrared light output from a display device according to an exemplary embodiment of the present invention;

FIG. 16B is a graph showing a light detection efficiency of the display device shown in FIG. 16A, according to an exemplary embodiment of the present invention;

FIG. 16C is a view showing a width and a focal length of a first lens unit according to a numerical aperture, according to an exemplary embodiment of the present invention;

FIG. 17 is a timing diagram showing signals generated in a three-dimensional mode display device according to an exemplary embodiment of the present invention;

FIG. 18A is a cross-sectional view showing a display device operated in a display period of the three-dimensional mode, according to an exemplary embodiment of the present invention; and

FIG. 18B is a cross-sectional view showing a display device operated in a detection period of the three-dimensional mode, according to an exemplary embodiment of the present invention.

### DETAILED DESCRIPTION OF THE EMBODIMENTS

It will be understood that when an element or layer is referred to as being “on”, “connected to” or “coupled to” another element or layer, it can be directly on, connected or coupled to the other element or layer or intervening elements or layers may be present. Like numbers may refer to like elements throughout the attached drawings and the written description.

As used herein, the singular forms, “a”, “an” and “the” are intended to include the plural forms as well, unless the context clearly indicates otherwise.

Hereinafter, exemplary embodiments of the present invention will be explained in detail with reference to the accompanying drawings.

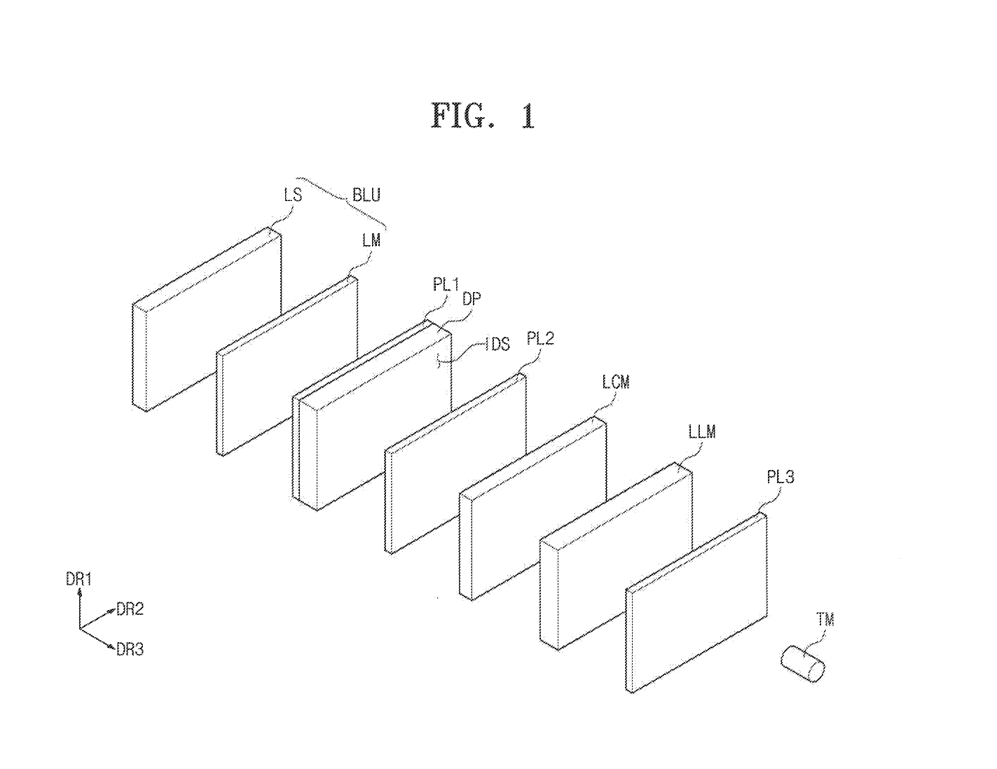

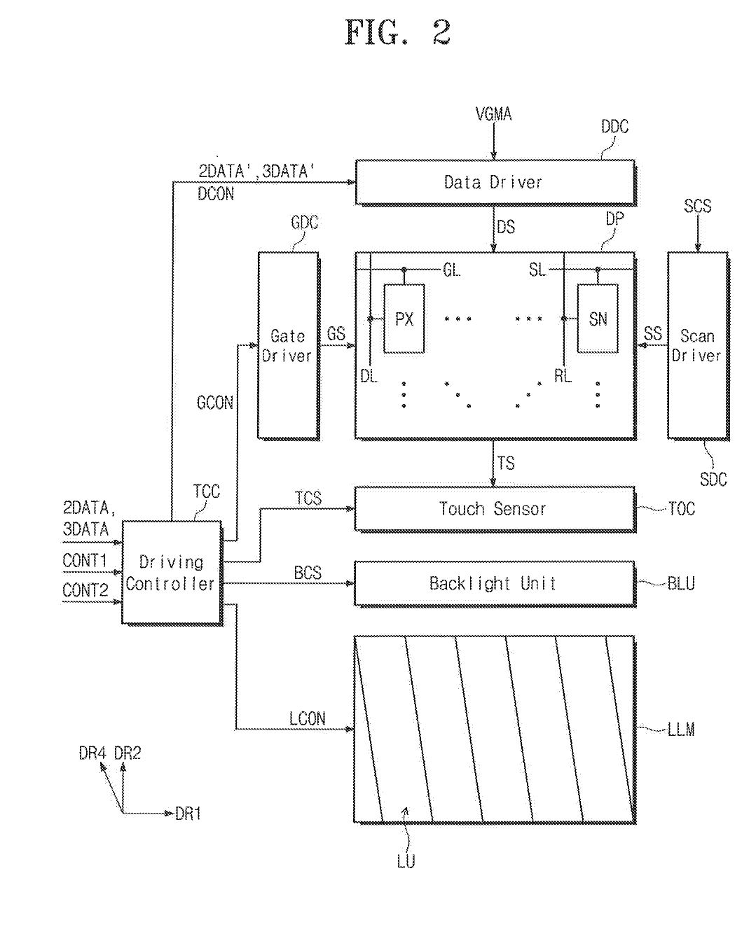

FIG. 1 is an exploded perspective view showing a display device according to an exemplary embodiment of the present invention and FIG. 2 is a block diagram showing a display device according to an exemplary embodiment of the present invention.

Referring to FIG. 1, a display device includes a backlight unit BLU, a display panel DP, a liquid crystal lens LLM, a distance control member LCM, and a plurality of polarizers PL1, PL2, and PL3. Although not shown in FIG. 1, the display device includes a light sensor SN (refer to FIG. 2).

Referring to FIG. 2, the display device further includes a circuit part to control the backlight unit BLU, the display panel DP, the light sensor SN, and the liquid crystal lens LLM, The circuit part includes a driving controller TCC, a gate driver GDC, a data driver DDC, a scan driver SDC, and a touch sensor TOC.

As shown in FIGS. 1 and 2, the backlight unit Bill provides a light to the display panel DP. The backlight unit BLU includes a light source LS and an optical member LM. The light source LS outputs a visible light and a detection light. The detection light has a wavelength different from that of the visible light. In the present exemplary embodiment, the detection light will be referred to as an infrared light.

The visible light and the infrared light are output from the light source LS in different periods from each other. The visible light is output in a display period in which an image is displayed, and the infrared light is output in a detection period in which an external input is detected.

The optical member LM is disposed on the light source LS. The optical member LM can increase the efficiency of the light incident to the display panel DR The optical member LM changes or scatters a path of the light provided from the light source LS.

The display panel DP is disposed on the backlight unit BLU. The display panel DP is a transmissive display panel. In the present exemplary embodiment, a liquid crystal display panel will be described as the display panel DP.

The display panel DP includes a display surface IDS defined by a first directional axis DR1 and a second directional axis DR2 substantially perpendicular to the first directional axis DR1. The display panel DP displays the image in a thickness direction (hereinafter, referred. to as a third directional axis DR3) of the display device through the display surface IDS. The display panel DP displays a two-dimensional (2D) image when the display device is operated in a 2D mode and displays a three-dimensional (3D) image when the display device is operated in a 3D mode. The 3D image may be a multi-viewpoint image.

The light sensor SN is disposed on the backlight unit BLU. In the present exemplary embodiment, the light sensor SN is disposed inside the display panel DP. A portion of the infrared light output to the outside of the display device is reflected by an input device TM. The light sensor SN receives the infrared light reflected by the input device TM and is activated.

The light sensor SN may be disposed on the outside of the display panel DP. The display device may further include a functional member to sense an external input. The light sensor SN may be disposed on the functional member. The functional member includes at least one substrate, the light sensor SN disposed on the substrate, signal lines, and a circuit part to control the light sensor SN.

The liquid crystal lens LLM is disposed on the display panel DP. The liquid crystal lens LLM includes a plurality of electrodes (not shown) and a liquid crystal layer (not shown). The electrodes and the liquid crystal layer form lens units LU. The liquid crystal lens LLM may form the lens units LU to have different functions from each other according to the operation mode of the display device, e.g., the 2D mode, the 3D mode, the display mode, the detection mode, etc. The lens units LU include a first lens unit (not shown) and a second lens unit (not shown), which have different functions from each other. The first lens unit can increase the light sensing efficiency of the light sensor SN and the second lens unit separates the 3D image into the multi-viewpoint image. Each lens unit LU extends in a fourth directional axis DR4 crossing the first directional axis DR3.

The distance control member LCM is disposed between the liquid crystal lens LLM and the display panel DP. The distance control member LCM controls a first inner focal length (not shown) of the first lens unit and a second inner focal length (not shown) of the second lens unit. The distance control member LCM may be omitted.

The polarizers PL1, PL2, and PL3 include a first polarizer PL1 disposed between the backlight unit BLU and the display panel DP, a second polarizer PL2 disposed between the display panel DP and the liquid crystal lens LLM, and a third polarizer PL3 disposed on the liquid crystal lens LLM. Each of the first, second, and third polarizers PL1, PL2, and PL3 includes optical axes, e.g., a transmission axis and a blocking axis. The number of the polarizers PL1, PL2, and PL3 is changed depending on a type of the display panel DP.

The transmission axis of the first polarizer PL1 is substantially parallel to or substantially perpendicular to the transmission axis of the second polarizer PL2. The first and second polarizers PL1 and PL2 transmit or block the light provided from the backlight unit BLU in accordance with an arrangement of the liquid crystal layer.

The third polarizer PL3 polarizes the multi-viewpoint image exiting from the liquid crystal lens LLM in a predetermined direction. The transmission axis of the third polarizer PL3 may be substantially parallel to the transmission axis of the second polarizer PL2. The transmission axis of the third polarizer PL3 may be substantially parallel to the fourth directional axis DR4. The transmission axis of the third polarizer PL3 may be changed depending on an alignment mode of the liquid crystal layer of the liquid crystal lens.

Hereinafter, the circuit part will be described in detail with reference to FIG. 2.

The driving controller TCC receives image signals 2DATA and 3DATA. The image signals 2DATA and 3DATA include a 2D image signal 2DATA or a 3D image signal 3DATA. When the display device is operated in the 2D mode, the driving controller TCC receives a first control signal CON1, and when the display device is operated in the 3D mode, the driving controller TCC receives a second control signal CON2. For instance, the first and second control signals CON1 and CON2 include control signals corresponding to each operation mode, e.g., a vertical synchronization signal, a horizontal synchronization signal, and a plurality of clock signals.

The driving controller TCC applies a data control signal DCON to the data driver DDC. The driving controller TCC converts a data format of the image signals 2DATA and 3DATA to a data format appropriate to an interface between the data driver DDC and the driving controller TCC and applies the converted image signals 2DATA′ and 3DATA′ to the data driver DDC.

The data control signal DCON includes a horizontal start signal to start an operation of the data driver DDC, a polarity control signal to control a polarity of a data signal DS, and a load signal to determine an output timing of the data signal DS. The data driver DDC receives a gamma voltage VGMA. The data driver 300 converts the image signals 2DATA′ and 3DATA′ to the data signal DS using the gamma voltage VGMA and outputs the data signal DS through a data line DL. A pixel PX connected to a gate line GL and the data line DL is turned on by a gate signal GS and receives the data signal DS.

In addition, the driving controller TCC applies a scan control signal SCS to the scan driver SDC and applies a touch sensor control signal TCS to the touch sensor TOC. The scan control signal SCS includes a vertical start signal to start an operation of the scan driver SDC and a scan clock signal to determine an output timing of a scan signal SS. The touch sensor control signal TCS may include a clock signal.

The scan driver SDC applies the scan signal SS to a scan line SL. The light sensor SN is turned on in response to the scan signal SS. The touch sensor TOC senses a touch signal TS through a read-out line RL. The touch signal TS is generated when the light sensor SN is activated by the infrared light reflected by the input device TM (refer to FIG. 1). The touch sensor TOC calculates a 2D coordinate value of a position indicated by the input device TM on the basis of the touch signal TS.

The driving controller TCC applies a light source control signal BCS to the backlight unit BLU. The light source control signal BCS may include a selection signal to determine the output of the visible light or the infrared light.

The driving controller TCC applies a liquid crystal lens control signal LCON to the liquid crystal lens LLM. The liquid crystal lens LLM is turned on or off in response to the liquid crystal lens control signal LCON. The liquid crystal lens LLM forms the first lens unit or the second lens unit in response to the liquid crystal lens control signal LCON.

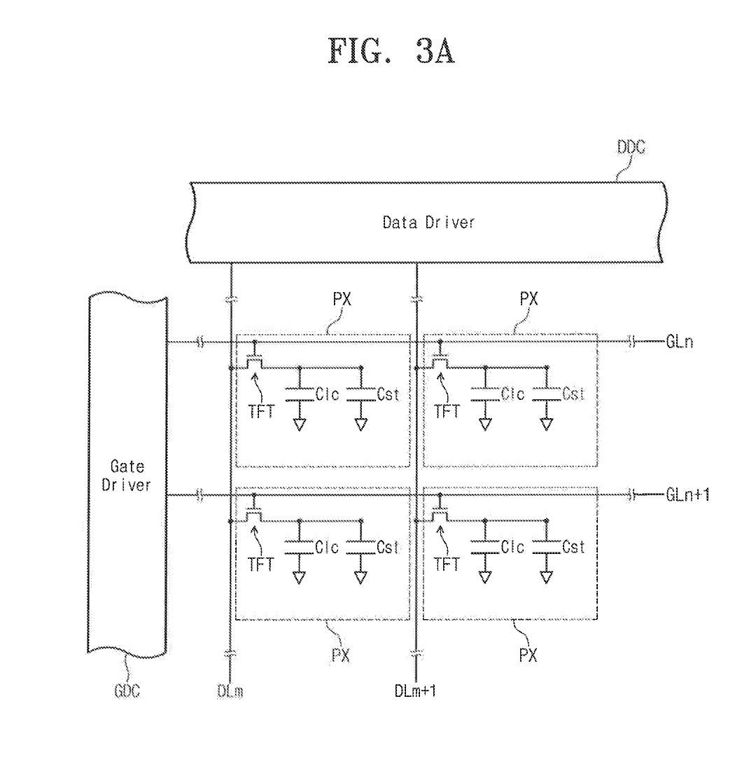

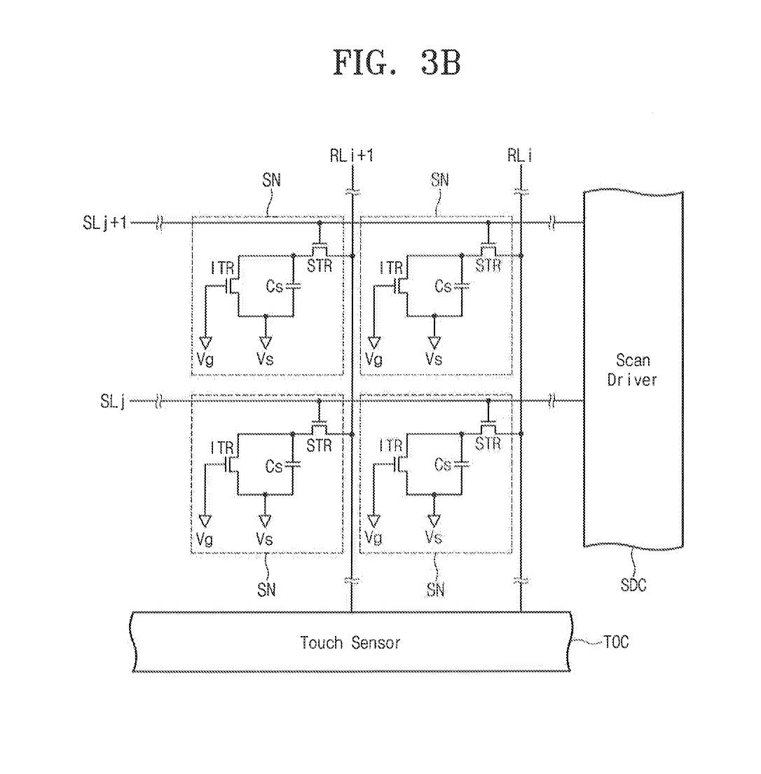

FIG. 3A is an equivalent circuit diagram showing the pixel PX according to an exemplary embodiment of the present invention and FIG. 3B is an equivalent circuit diagram showing the light sensor SN according to an exemplary embodiment of the present invention. The pixel PX and the light sensor SN will be described in detail with reference to FIGS. 2, 3A, and 3B.

The display device includes a plurality of pixels PX. Each pixel PX is connected to a corresponding gate line of gate lines and corresponding data line of data lines.

FIG. 3A shows an n-th gate line GLn, an (n+1)th gate line GLn+1, m-th data line DLm, an (m+1)th data line DLm+1, and four pixels PX connected to the n-th gate line GLn, the (n+1)th gate line GLn+1, the m-th data line DLm, and the (m+1)th data line DLm+1. Each of the four pixels PX includes a thin film transistor TFT connected to the corresponding gate line and the corresponding data line and a liquid crystal capacitor Cle connected to the thin film transistor TFT. Each of the four pixels PX includes a storage capacitor Cst connected to the liquid crystal capacitor Clc in parallel. The storage capacitor Cst may be omitted.

Responsive to the gate signal applied to the corresponding gate line, the thin film transistor TFT outputs a pixel voltage corresponding to the data signal applied to the corresponding data line. The liquid crystal capacitor Clc and the storage capacitor Cst are charged with the pixel voltage.

The display device includes a plurality of light sensors SN. Each of the light sensors SN is connected to a corresponding scan line of scan lines and a corresponding read-out line of read-out lines. FIG. 3B shows a j-th scan line SLj, a (j+1)th scan line SLj+1, an i-th read-out line RLi, an (i+1)th read-out line RLi+1, and four light sensors SN connected to the j-th scan line SLj, the (j+1)th scan line SLj+1, the i-th read-out line RLi, and the (i+1)th read-out line RLi+1.

The four light sensors SN correspond to the pixels PX. For instance, one of the four sensors SN may correspond to one of the four pixels PX shown in FIG. 3A. Each of the four light sensors SN includes a switching transistor STR, a photo-transistor IRT, and a capacitor Cs. The switching transistor STR is connected to the corresponding scan line and the corresponding read-out line. The switching transistor STR is connected to the capacitor Cs and the photo-transistor IRT.

A first electrode of the capacitor Cs is connected to an output electrode of the switching transistor STR and a second electrode of the capacitor Cs receives a first bias voltage Vs. A control electrode of the photo-transistor IRT receives a second bias voltage Vg. The second bias voltage Vg has a level lower than that of the first bias voltage Vs.

An input electrode of the photo-transistor IRT receives the first bias voltage Vs. An output electrode of the photo-transistor IRT is connected to the switching transistor STR. The photo-transistor IRT generates a photocurrent corresponding to an amount of the infrared light incident thereto. A semiconductor layer of the photo-transistor IRT includes silicon germanium (SiGe). The structure of the photo-transistor may be changed in accordance with a wavelength range of the detection light.

When the scan signal SS (refer to FIG. 2) is applied to the corresponding scan line, the switching transistor STR is turned on. The capacitor Cs is charged with a voltage provided through the corresponding read-out line. Then, when the photocurrent is generated in the photo-transistor IRT, an electric potential of the corresponding read-out line is varied. The varied electric potential of the corresponding read-out line corresponds to the touch signal TS. The touch sensor TOC calculates the 2D coordinate value of the position indicated by the input device TM on the basis of a timing at which the scan signal is applied to the corresponding scan line and a position of the read-out line from which the touch signal TS is sensed among the read-out lines.

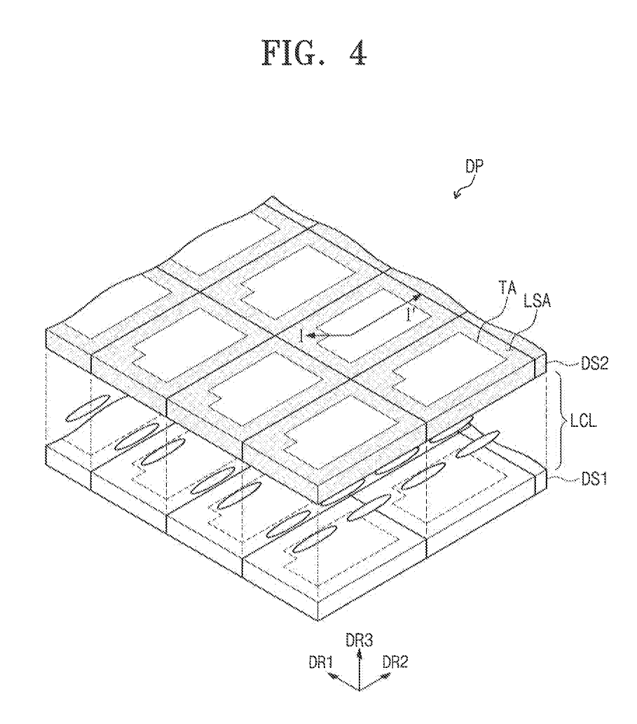

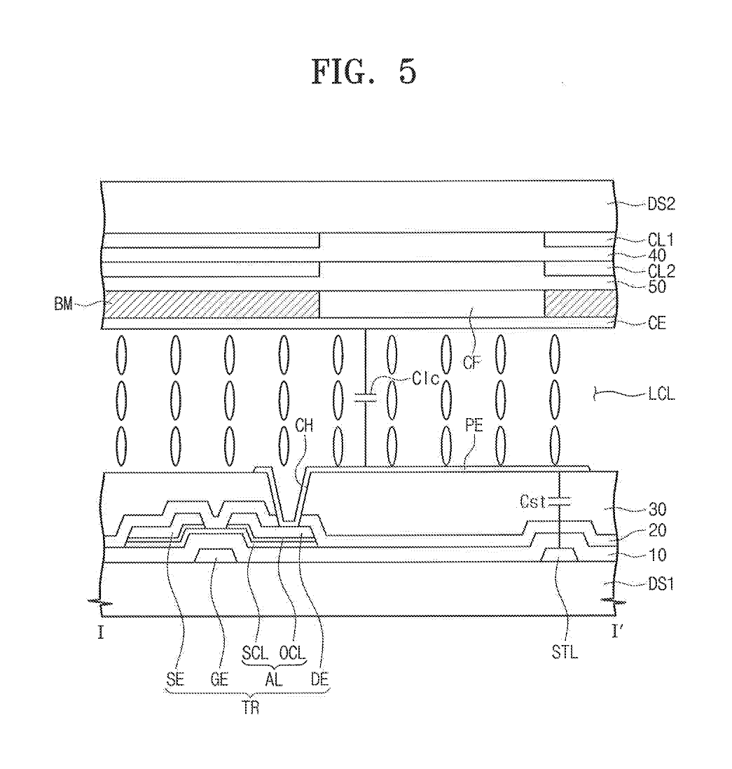

FIG. 4 is a perspective view showing a portion of a display panel according to an exemplary embodiment of the present invention and FIG. 5 is a cross-sectional view taken along a line I-I′ shown in FIG. 4, according to an exemplary embodiment of the present invention. Hereinafter, a structure of the display panel will be described in detail with reference to FIGS. 4 and 5.

The display panel DP includes a first base substrate DS1 and a second base substrate DS2. The first and second base substrate DS1 and DS2 are disposed in the third directional axis DR3 and spaced apart from each other. A liquid crystal layer LCL is disposed between the first and second base substrates DS1 and DS2.

The display panel DP includes transmission areas TA through which the visible light and the infrared light transmit and a peripheral area LSA adjacent to the transmission areas TA. The peripheral area LSA blocks the visible light and the infrared light. The peripheral area LSA may be an area with which a black matrix BM is overlapped. Color filters CF are overlapped with the transmission areas TA.

The pixels PX (refer to FIG. 3A) are disposed to overlap with the transmission areas TA. Consequently, the pixels PX are overlapped with the color filters CF. One of the light sensors SN (refer to FIG. 3B) is overlapped with the peripheral area LSA. The gate line, the data line, the scan line, and the read-out line are disposed to overlap with the peripheral area LSA.

Referring to FIG. 5, the thin film transistor TR is disposed on the first base substrate DS1. The thin film transistor TR includes a control electrode GE connected to the corresponding gate line, an active part AL overlapped with the control electrode GE, an input electrode SE connected to the corresponding data line, and an output electrode DE disposed to be spaced apart from the input electrode SE.

The liquid crystal capacitor Clc includes a pixel electrode PE and a common electrode CE. The storage capacitor Cst includes the pixel electrode PE and a portion of a storage line STL overlapped with the pixel electrode PE.

The control electrode GE and the storage line STL are disposed on a surface of the first base substrate DS1. A first insulating layer 10 is disposed on the surface of the first base substrate DS1 to cover the control electrode GE and the storage line STL. The active part AL is disposed on the first insulating layer 10 to overlap with the control electrode GE. The active part AL includes a semiconductor layer SCL and an ohmic contact layer OCL. The semiconductor layer SCL is disposed on the first insulating layer 10 and the ohmic contact layer OCL is disposed on the semiconductor layer SCL.

The output electrode DE and the input electrode SE are disposed on the active part AL. The output electrode DE and the input electrode SE are disposed to be spaced apart from each other. Each of the output electrode DE and the input electrode SE is partially overlapped with the control electrode GE. A second insulating layer 20 is disposed on the first insulating layer 10 to cover the active part AL, the output electrode DE, and the input electrode SE. A third insulating layer 30 is disposed on the second insulating layer 20. The third insulating layer 30 provides a planarized surface.

Each of the first, second, and third insulating layers 10, 20, and 30 includes an inorganic material or an organic material. Each of the first and second insulating layers 10 and 20 may be an inorganic layer, and the third insulating layer 30 may be an organic layer.

The pixel electrode PE is disposed on the third insulating layer 30. The pixel electrode PE is connected to the output electrode DE through a contact hole CH formed through the second and third insulating layers 20 and 30. An alignment layer (not shown) may be further disposed on the third insulating layer 30 to cover the pixel electrode PE.

A first conductive layer CL1 is disposed on the second base substrate DS2. The first conductive layer CL1. includes a plurality of conductive patterns. The first conductive layer CL1 includes the scan line SL (refer to FIG. 2). A fourth insulating layer 40 is disposed on the first conductive layer CL1.

A second conductive layer CL2 is disposed on the fourth insulating layer 40. The second conductive layer CL2 includes a plurality of conductive patterns. The second conductive layer CL2 includes the read-out line RL (refer to FIG. 2). A fifth insulating layer 50 is disposed on the second conductive layer CL2. Each of the fourth and fifth insulating layers 40 and 50 includes an inorganic material or an organic material.

The black matrix BM and the color filters CF are disposed on the fifth insulating layer 50. The common electrode CE is disposed on the black matrix BM and the color filters CF. An alignment layer (not shown) may be disposed on the common electrode CE.

FIG. 5 shows a vertical alignment (VA) mode liquid crystal display panel as a representative example, but the present invention is not limited thereto. The VA mode liquid crystal display panel may be replaced with another liquid crystal display panel, e.g., a patterned vertical alignment (PVA) mode liquid crystal display panel, a twisted nematic (TN) mode liquid crystal display panel, an in-plane switching (IPS) mode liquid crystal display panel, a fringe-field switching (FFS) mode liquid crystal display panel, a plane to line switching (PLS) mode liquid crystal display panel, etc.

Although not shown, another insulating layer may be further disposed on the second base substrate DS2. In addition, the electrodes and the semiconductor layer of each of the switching transistor STR (refer to FIG. 3B) and the photo-transistor ITR (refer to FIG. 3B) may be disposed on the second base substrate DS2. The electrodes of each of the switching transistor STR (refer to FIG. 3B) and the photo-transistor ITR (refer to FIG. 3B) may be included in the first conductive layer CL1 and the second conductive layer CL2. In an exemplary embodiment, the black matrix BM and the color filters CF are disposed on the first base substrate DS1.

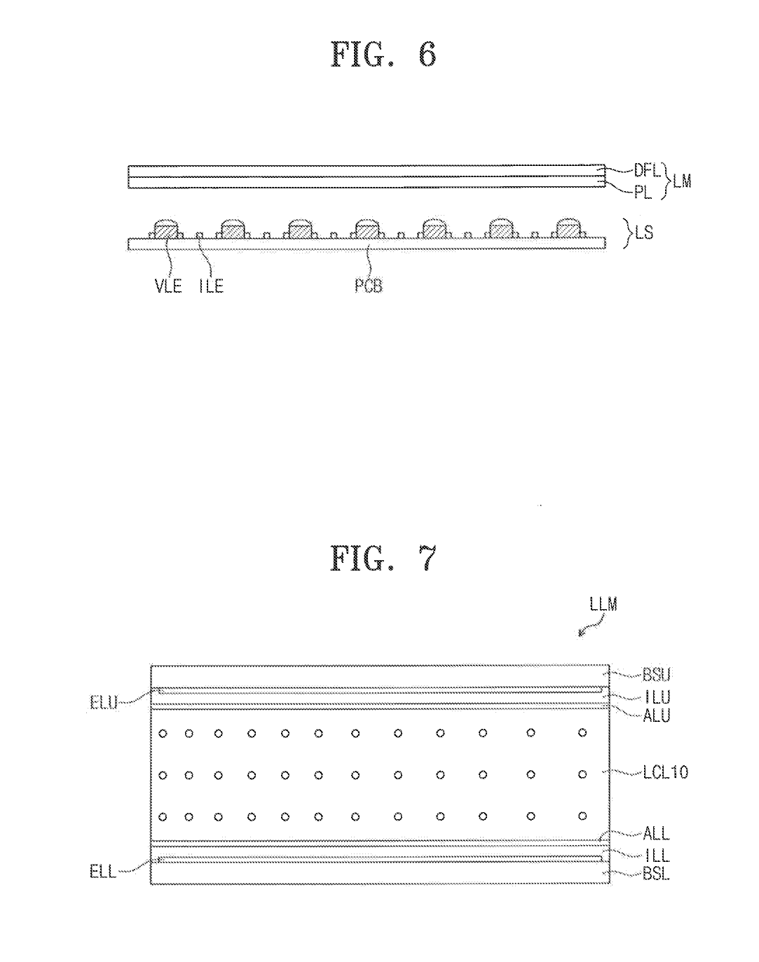

FIG. 6 is a side view showing the backlight unit BLU according to an exemplary embodiment of the present invention.

Referring to FIG. 6, the light source LS includes a circuit board PCB, first light emitting devices VLE mounted on the circuit board PCB, and second light emitting devices ILE mounted on the circuit board PCB. The circuit board PCB includes signal lines for transferring dimming signals to control the turning on and off of the first and second light emitting devices VLE and ILE. The first light emitting devices VLE emit the visible light and the second light emitting devices ILE emit the infrared light. The second light emitting devices ILE emit a white light or red, green, and blue lights.

The first light emitting devices VLE are alternately arranged with the second light emitting devices ILE. The first and second light emitting devices VLE and ILE may be light emitting diodes.

FIG. 6 shows a direct-illumination type light source LS, but the backlight unit BLU according to the present exemplary embodiment may include an edge-illumination type light source. The backlight unit BLU further includes a light guide plate when the backlight unit BLU includes the edge-illumination type light source. The first and second light emitting devices VLE and ILE provide the visible light and the infrared light to a side surface of the light guide plate.

The optical member LM includes a prism sheet PL and a diffusion sheet DFL. The prism sheet PL condenses the light provided from the light source LS in a direction substantially vertical to the display panel DP. The diffusion sheet DEL diffuses the light incident thereto to increase an amount of the light. A diffusion surface of the diffusion sheet DFL may be the same as a Lambertian surface. The optical member LM may further include a protective sheet disposed on the diffusion sheet DFL.

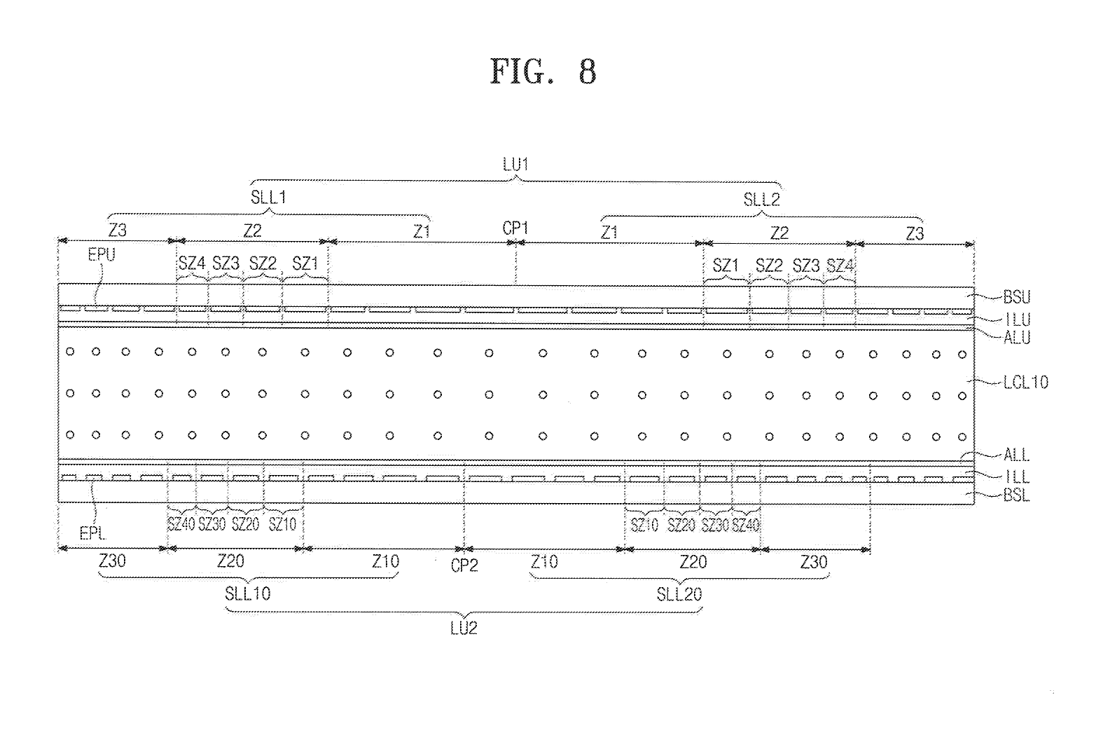

FIG. 7 is a cross-sectional view showing the liquid crystal lens LLM according to an exemplary embodiment of the present invention and FIG. 8 is an enlarged cross-sectional view showing the liquid crystal lens LLM according to an exemplary embodiment of the present invention. FIGS. 7 and 8 show the cross-sectional view taken along a direction (hereinafter, referred to as a horizontal direction) substantially perpendicular to the fourth directional axis DR4 (refer to FIG. 2). Hereinafter, the liquid crystal lens will be described in detail with reference to FIGS. 7 and 8.

Referring to FIG. 7, the liquid crystal lens LLM includes a lower electrode layer ELL disposed on a lower substrate BSL, an upper electrode layer ELU disposed on an upper substrate BSU spaced apart from the lower substrate BSL, and a liquid crystal layer LCL1O interposed between the lower electrode layer ELL and the upper electrode layer ELU.

The lower substrate BSL and the upper substrate BSU form a portion of the liquid crystal lens LLM or a portion of another optical member. Each of the lower substrate BSL and the upper substrate BSU may be a glass substrate or a transparent plastic substrate.

A lower insulating layer ILL is disposed on the lower substrate BSL to cover the lower electrode layer ELL. A lower alignment layer ALL is disposed on the lower insulating layer ILL. An upper insulating layer ILU is disposed on the upper substrate BSU to cover the upper electrode layer ELU. An upper alignment layer ALU is disposed on the upper insulating layer ILU. When the liquid crystal layer LCL10 is light-aligned, the lower alignment layer ALL and the upper alignment layer ALU may be omitted.

An alignment mode of the liquid crystal layer LCL10 is not limited to a specific mode. The liquid crystal layer LCL10 may be vertically aligned, horizontally aligned, or twist-aligned. When the liquid crystal layer LCL10 maintains an initial alignment thereof, the light passing through the liquid crystal layer LCL10 has a constant phase regardless of the area thereof. The liquid crystal layer LCL10 that maintains the initial alignment does not retard the phase of the light passing therethrough or retard the phase of the light passing therethrough by the constant phase. In other words, when the liquid crystal layer LCL10 maintains the initial alignment, the lens units are not formed.

When the arrangement of the liquid crystal layer LCL10 is varied, e.g., the liquid crystal layer LCL10 has different arrangements according to the areas thereof, the lens units are formed. The arrangement of the liquid crystal layer LCL10 is changed when an electric field is applied to the liquid crystal layer LCL10. According to the arrangement of the liquid crystal layer LCL10, the first lens unit that senses the external input or the second lens unit that separates the 3D image into the multi-viewpoint image is formed.

As shown in FIG. 8, the lower electrode layer ELL includes a plurality of lower electrodes EPL and the upper electrode layer ELU includes a plurality of upper electrodes EPU. Each of the lower and upper electrodes EPL and EPU may have a bar shape extending in the fourth directional axis DR4.

In the present exemplary embodiment, each of the lower electrodes EPL is disposed on an upper surface of the lower substrate BSL, but a portion of the lower electrodes EPL may be disposed on a different layer from another portion of the lower electrodes EPL. For instance, the portion of the lower electrodes EPL may be disposed on the lower insulating layer ILL. In addition, a portion of the upper electrodes EPU may be disposed on a different layer from another portion of the upper electrodes EPL.

The first lens unit or the second lens unit is formed in accordance with a driving voltage applied to the upper electrodes EPU and the lower electrodes EPL. The first lens unit may be formed by controlling the driving voltage applied to the upper electrodes EPU and the second lens unit may be formed by controlling the driving voltage applied to the lower electrodes EPL.

FIG. 8 shows the upper electrodes EPU corresponding to one first lens unit LU1 and the lower electrodes EPL corresponding to one second lens unit LU2. In addition, FIG. 8 shows the liquid crystal layer LCL10 to which no electric field is applied. Hereinafter, the first and second lens units LU1 and LU2 will be described in detail.

The first lens unit LU1 includes a left-side area SLL1 and a right-side area SLL2 respectively disposed at both sides of a center portion CP1 of the first lens unit LU1. The left-side area SLL1 and the right-side area SLL2 may be symmetrical with each other relative to the center portion CP1 of the first lens unit LU1.

Each of the left-side area SSL1 and the right-side area SSL2 includes a plurality of areas Z1, Z2, and Z3, e.g., three areas, which are distinct from each other along the horizontal direction. The three areas Z1, Z2, and Z3 have a width that becomes smaller as a distance from the center portion CP1 of the first lens unit LU1 increases. The width corresponds to a size in the horizontal direction.

Each of the three areas Z1, Z2, and Z3 includes a plurality of sub-areas SZ1, SZ2, SZ3, and SZ4 distinct from each other along the horizontal direction, e.g., four sub-areas. The four sub-areas SZ1, SZ2, SZ3, and SZ4 have a width that becomes smaller as a distance from the center portion CP1 of the first lens unit LU1 increases.

The upper electrodes EPU are disposed to respectively correspond to the four sub-areas SZ1, SZ2, SZ3, and SZ4. A width in the horizontal direction of the upper electrodes EPU corresponds to the width in the horizontal direction of the four sub-areas SZ1, SZ2, SZ3, and SZ4. In other words, widths of the upper electrodes EPU respectively disposed in the four sub-areas SZ1, SZ2, SZ3, and SZ4 become smaller as a distance from the center portion CP1 of the first lens unit LU1 increases.

The second lens unit LU2 has a width smaller than that of the first lens unit LU1. The second lens unit LU2 includes a left-side area SLL10 and a right-side area SLL20, which are respectively disposed at both sides of a center portion CP2 of the second lens unit LU2. The left-side area SLL10 and the right-side area SLL20 may be symmetrical with each other relative to the center portion CP2 of the second lens unit LU2. Each of the left-side area SLL10 and the right-side area SLL20 includes three areas Z10, Z20, and Z30 distinct from each other along the horizontal direction. Each of the three areas Z10, Z20, and Z30 includes four sub-areas SZ10, SZ20, SZ30 and SZ40 distinct from each other along the horizontal direction.

The lower electrodes EPL are disposed to respectively correspond to the four sub-areas SZ10, SZ20, SZ30, and SZ40. A width in the horizontal direction of the lower electrodes EPL corresponds to the width in the horizontal direction of the four sub-areas SZ10, SZ20, SZ30, and SZ40. Accordingly, the width of each of the lower electrodes EPL is smaller than that of a corresponding upper electrode of the upper electrodes EPU.

In the present exemplary embodiment, the lower electrodes EPL may be integrally formed as a single unitary and individual unit. In this case, the liquid crystal lens LLM may form only the first lens unit LU1 to sense the external input, and thus the display panel DP may display only the 2D image.

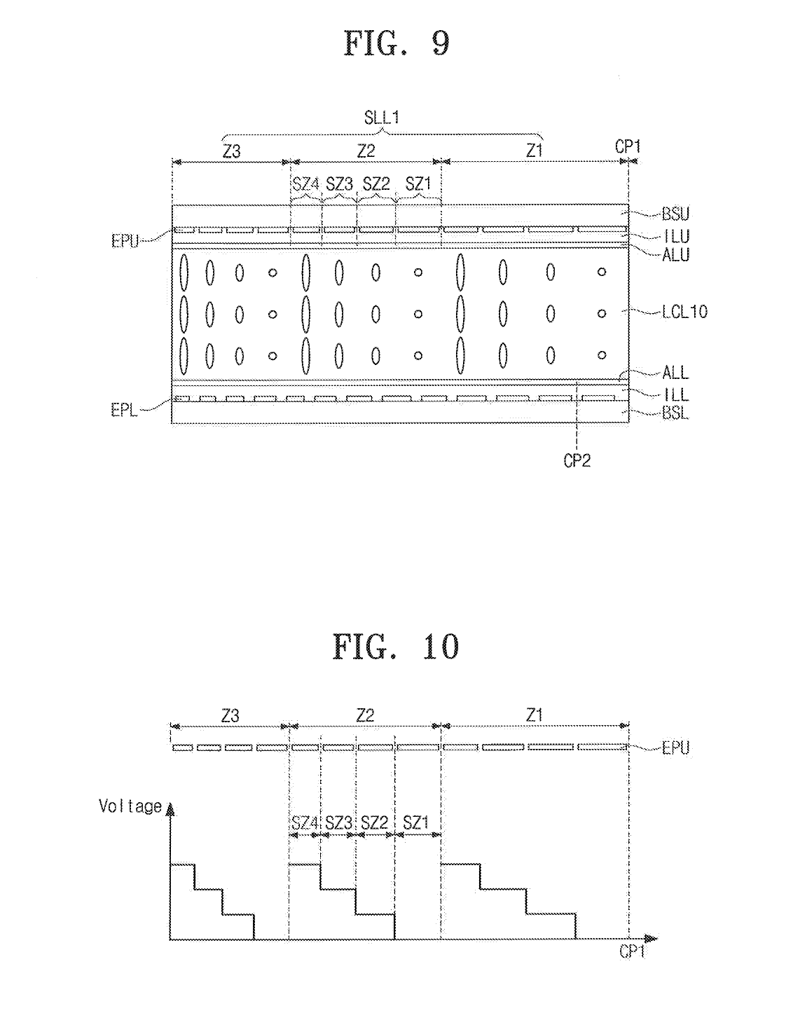

FIG. 9 is a cross-sectional view showing a portion of the first lens unit LU1 according to an exemplary embodiment of the present invention, FIG. 10 is a graph showing voltages applied to electrodes that form the first lens unit LU1 according to an exemplary embodiment of the present invention, and FIG. 11 is a graph showing a phase distribution of the portion of the first lens unit LU1 according to an exemplary embodiment of the present invention. Hereinafter, the left-side area SLL1 of the first lens unit LU1 will be described in detail.

Referring to FIG. 9, the liquid crystal layer LCL10 of the first lens unit LU1 has different arrangements from each other in accordance with areas thereof. As shown in FIG. 10, the upper electrodes EPU disposed to respectively correspond to the sub-areas SZ1, SZ2, SZ3, and SZ4 in each of the three areas Z1, Z2, and Z3 receive a first step-shaped voltage having the level that becomes high as it goes from the right to the left.

Referring to the second area Z2 of the areas Z1, Z2, and Z3, the upper electrode of the first sub-area SZ1, which is disposed at a rightmost position, receives the voltage having the lowest level, and the upper electrode of the fourth sub-area SZ4, which is disposed at a leftmost position, receives the voltage having the highest level. The upper electrodes disposed at corresponding sub-areas of the areas Z1, Z2, and Z3 receive the voltage having the same level. In the present exemplary embodiment, the upper electrodes disposed at corresponding sub-areas of the areas Z1, Z2, and Z3 receive the voltage having the level that becomes smaller as it goes from the right to the left.

In this case, the lower electrodes EPL receive a second voltage having a constant level regardless of the areas thereof. The second voltage has substantially the same level as that of the voltage applied to the upper electrode in the fourth sub-area SZ4. The second voltage may be a ground voltage. Although not shown, the upper electrodes EPU corresponding to the right-side area SLL2 of the first lens unit LU1 may receive a third voltage obtained by reversing left and right sides of the graph shown in FIG. 10. The lower electrodes EPL corresponding to the right-side area SLL2 of the first lens unit LU1 receive the second voltage regardless of the areas thereof.

As shown in FIG. 9, the arrangement of the liquid crystal layer LCL10 is changed to correspond to the electric field formed in each of the areas Z1, Z2, and Z3. The arrangement of liquid crystal molecules included in the sub-areas SZ1, SZ2, SZ3, and SZ4 changes more from the right to the left. The arrangement of the liquid crystal molecules disposed in the first sub-area SZ1 of each of the areas Z1, Z2, and Z3 may not be changed.

As shown in FIG. 11, the light passing through the liquid crystal layer LCL10 has its phase changed depending on the areas of the liquid crystal layer LCL10 according to the change in arrangement of the liquid crystal layer LCL10. The first sub-area SZ1 of each of the three areas Z1, Z2, and Z3 has a phase retardation value greater than that of the other sub-areas SZ2, SZ3, and SZ4 of each of the three areas Z1, Z2, and Z3. The light passing through the three areas Z1, Z2, and Z3 has a step-shaped phase changed according to the four sub-areas SZ1, SZ2, SZ3, and SZ4.

In the present exemplary embodiment, an intensity of the electric field is proportional to the variation in arrangement of the liquid crystal molecules, but the intensity of the electric field may be inversely proportional to the variation in arrangement of the liquid crystal molecules due to a dielectric anisotropy of the liquid crystal molecules. In addition, the variation in arrangement of the liquid crystal molecules is inversely proportional to the phase delay value, but the variation in arrangement of the liquid crystal molecules may be proportional to the phase delay value due to a refractive anisotropy of the liquid crystal molecules.

Although not shown, the lower electrodes EPL disposed to correspond to the left area SLL10 of the second lens unit LU2 may receive a fourth step-shaped voltage. The second voltage may have the shape as shown in FIG. 10. However, the fourth voltage may be a step shaped voltage having a different level from that of the second voltage. In this case, the upper electrodes EPU receive a fifth voltage having a constant level regardless of the areas thereof. The fifth voltage may he the ground voltage.

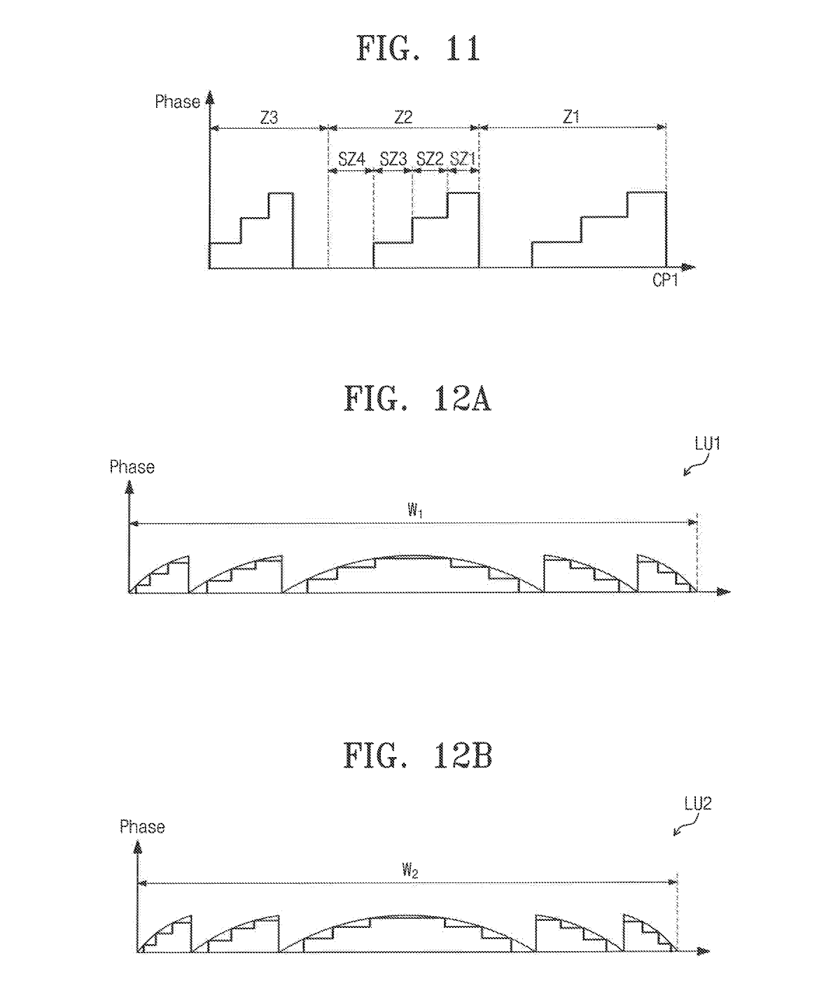

FIG. 12A is a graph showing a phase distribution of the light passing through one first lens unit LU1 according to an exemplary embodiment of the present invention, and FIG. 12B is a graph showing a phase distribution of the light passing through one second lens unit LU2 according to an exemplary embodiment of the present invention.

Each of the first and second lens units LU1 and LU2 may serve as a Fresnel zone plate lens. The first lens unit LU1 has a first inner focal length and the second lens unit LU2 has a second inner focal length different from the first inner focal length.

The first lens unit LU1 has a width different from that of the second lens unit LU2. The width of the first lens unit LU1 corresponds to a first width W₁ and the width of the second lens unit LU2 corresponds to a second width W₂.

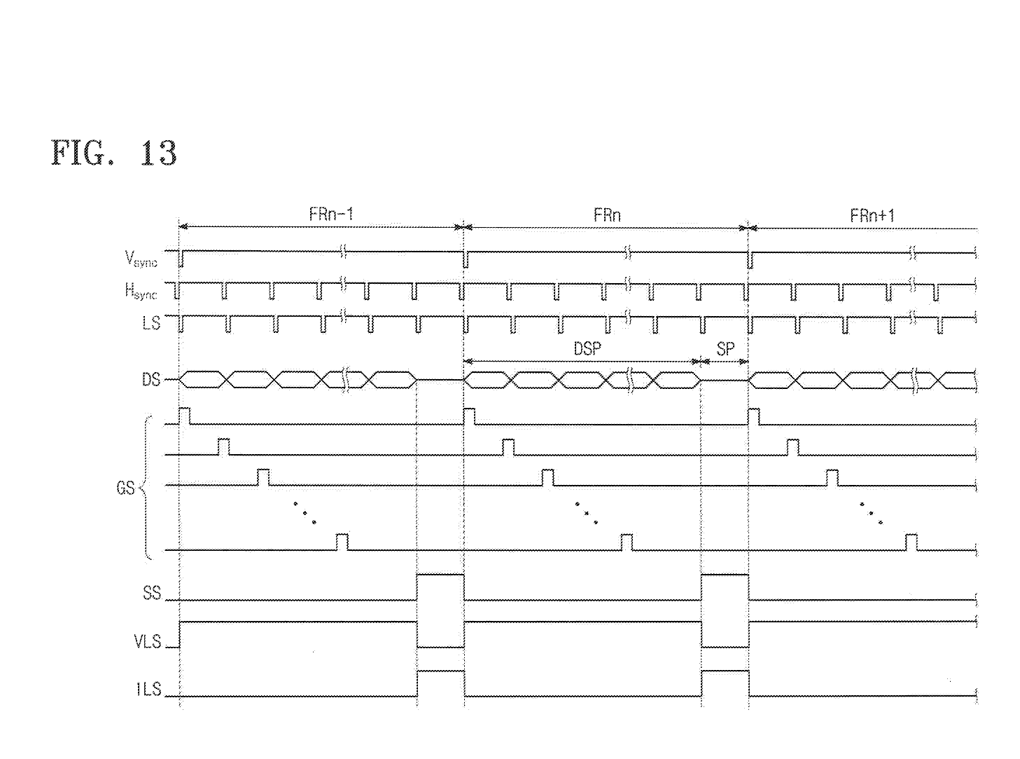

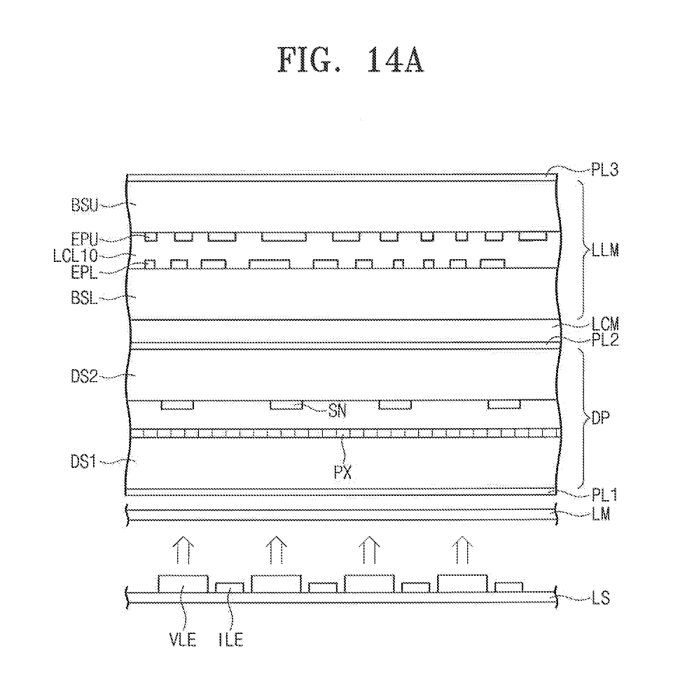

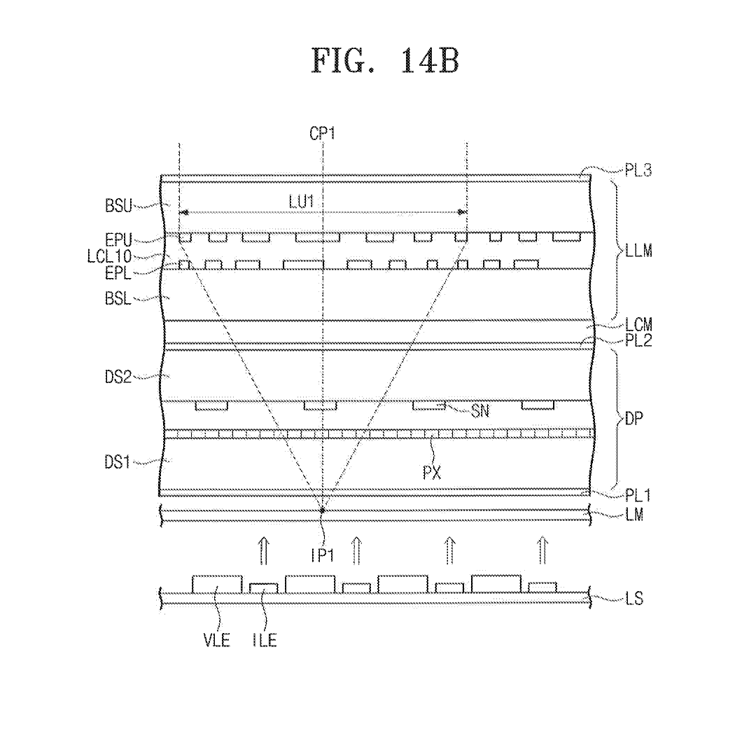

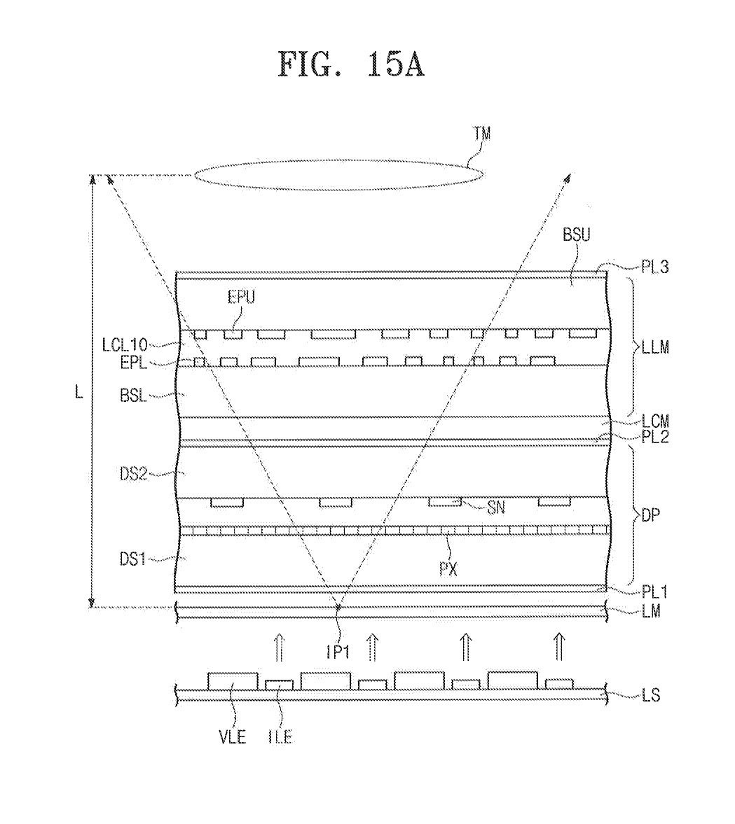

FIG. 13 is a timing diagram showing signals generated in a 2D mode display device according to an exemplary embodiment of the present invention, FIG. 14A is a cross-sectional view showing a display device operated in a display period of the 2D mode according to an exemplary embodiment of the present invention, and FIG. 14B is a cross-sectional view showing a display device operated in a detection period of the 2D mode according to an exemplary embodiment of the present invention. Hereinafter, a driving method of the 2D mode display device will be described in detail.

Referring to FIG. 13, a vertical synchronization signal Vsync defines a plurality of frame periods FRn−1, FRn, and FRn+1. Each of the frame periods FRn−1, FRn, and FRn+1 includes a display period DSP and a detection period SP. A horizontal synchronization signal. Hsync defines a plurality of horizontal periods during which the data signals DS are output. The gate signals GS are applied to the display panel DP every horizontal period of the display period DSP. The gate signals GS have different activation periods from each other. The data signals DS are applied to the display panel DP in synchronization with the load signal RS every horizontal period of the display period DSP.

A first dimming signal VLS that controls the, first light emitting device VLE has a high level during the display period DSP and has a low level during the detection period SP. A second dimming signal ILS that controls the second light emitting device ILE has a phase opposite to that of the first dimming signal VLS.

The data signals DS are not output during the detection period SP. In the present exemplary embodiment, the detection period SP corresponds to one horizontal period, but it is not be limited thereto. In other words, the detection period SP may correspond to plural horizontal periods. In addition, a blank signal may be applied to the display panel DP during the detection period SP. The display panel DP applied with the blank signal displays a black image.

The scan signal SS is output during the detection period SP. The scan signal SS may include plural signals activated in different periods from each other. The light sensor SN is activated by the scan signal SS.

The 2D mode display device display's the 2D image every display period DSP of each of the frame periods FRn−1, FRn, and FRn+1. The 2D mode display device senses the external input every detection period SP of each of the frame periods FRn−1, FRn, and FRn+1.

Referring to FIG. 14A, the first light emitting device VLE is turned on during the display period DSP to emit the visible light. In this case, the second light emitting device ILE is turned off. The display panel DP displays the 2D image using the visible light during the display period DSP.

The liquid crystal lens LLM does not form the lens unit. The upper electrodes EPU and the lower electrodes EPL have the same electric potential. The upper electrodes EPU and the lower electrodes EPL may be applied with the same voltage, e.g., the ground voltage.

Referring to FIG. 14B, the second light emitting device ILE is turned on during the detection period SP to emit the infrared light. In this case, the first light emitting device VLE is turned off. During the detection period SP, the light sensor SN receives the infrared light reflected by the input device TM (refer to FIG. 1) to sense the external input.

Although not shown, the light sensor SN may further include a filter or a light blocking layer to prevent the infrared light emitted from the second light emitting device ILE from being directly incident to the light sensor SN.

The liquid crystal lens LLM forms the first lens unit LU1 (refer to FIG. 12A). The first lens unit LU1 has a first inner focal point IP1 defined by the optical member LM. The first lens unit LU1 condenses the infrared light emitted from the second light emitting device ILE to the input device TM. Hereinafter, the first lens unit LU1 will be described in detail.

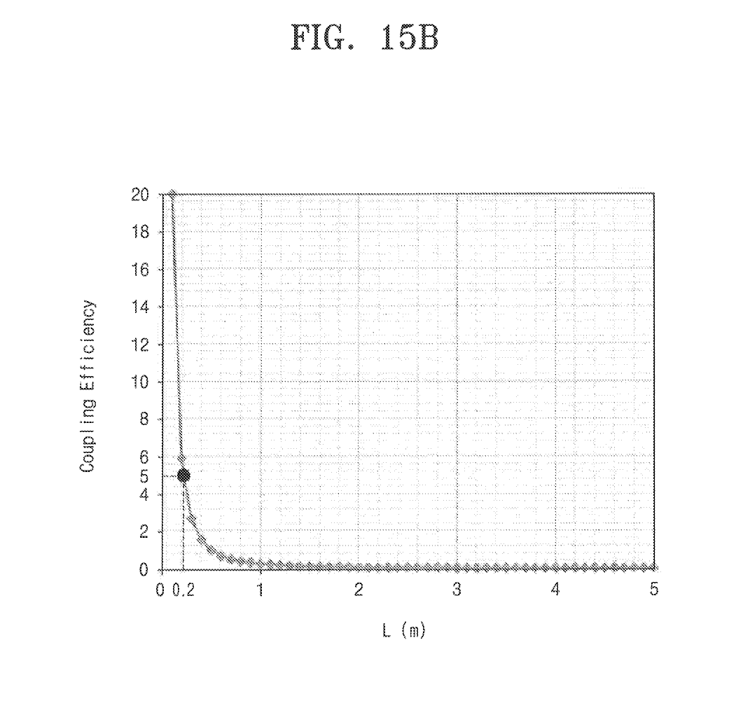

FIG. 15A is a view showing a path of an infrared light output from a display device according to a comparative example and FIG. 15B is a graph showing a light detection efficiency of the display device shown in FIG. 15A.

Referring to FIG. 15A, the infrared light emitted from the second light emitting device ILE is diffused while passing through the optical member LM. In particular, the diffusion surface of the diffusion sheet DFL (refer to FIG. 6) diffuses the infrared light similar to a Lambertian surface. The light exiting from the diffusion sheet DFL is incident to the input device TM disposed at the outside of the display device after passing through the display panel DP and the liquid crystal lens LLM.

FIG. 15B shows a simulated graph representing the efficiency of the amount of the light incident to the light sensor SN against the amount of the light exiting from the diffusion sheet DFL according to a distance L between the input device TM and the diffusion sheet DFL. The light incident to the light sensor SN corresponds to the portion of the light reflected by the input device TM among the light exiting through the diffusion sheet DFL.

No light may exit from the diffusion sheet DFL. When the amount of the light incident to the light sensor SN with respect to the amount of the light exiting from the diffusion sheet DFL is about 5% or more, the light sensor SN may sense the external input. According to FIG. 15B, when the light detection efficiency is about 5%, the distance L between the input device TM and the diffusion sheet DFL is about 0.2 m. In other words, the light sensor SN may sense the external input caused by the input device disposed in a distance range of about 0.2 m or less from the diffusion sheet DFL.

The distance L between the input device TM and the diffusion sheet DFL is substantially the same as a distance between an outer surface of the display device and the input device TM. The thickness of the display device may be ignored when considering the distance between the outer surface of the display device and the input device TM. According to the comparative example, the external input occurring at a position separated from the outer surface of the display device by about 0.2 m or more is not sensed by the light sensor SN. In other words, a range in which the light sensor SN senses the external input is limited to a specific range, e.g., about 0.2 m or less, in the display device according to the comparative example.

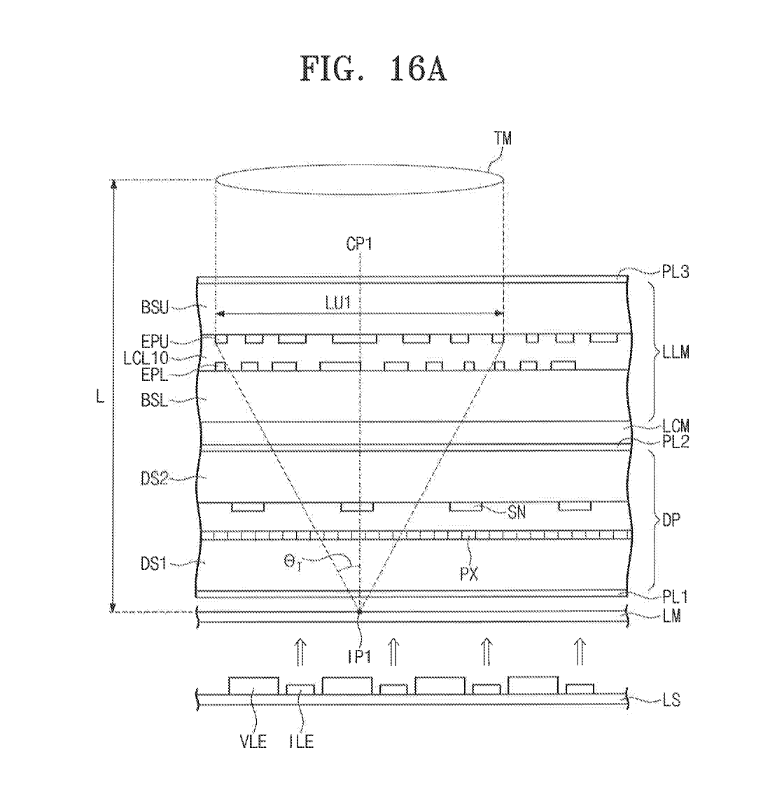

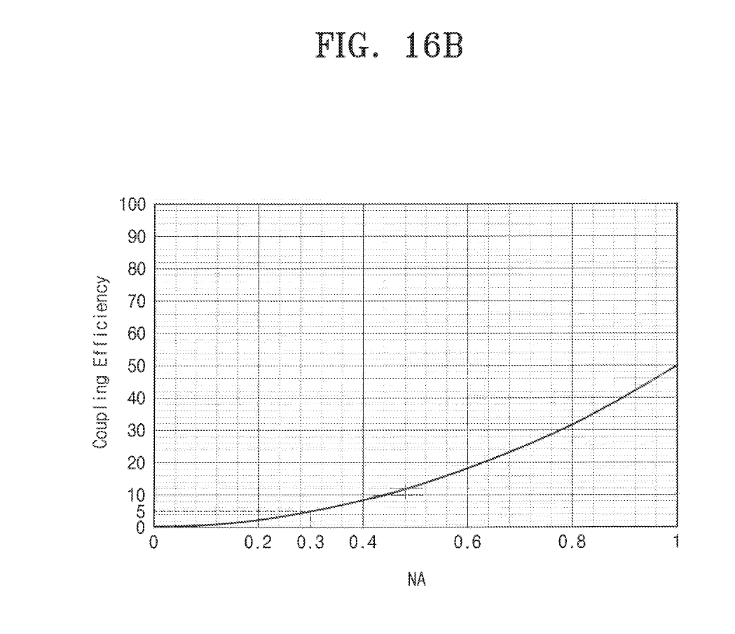

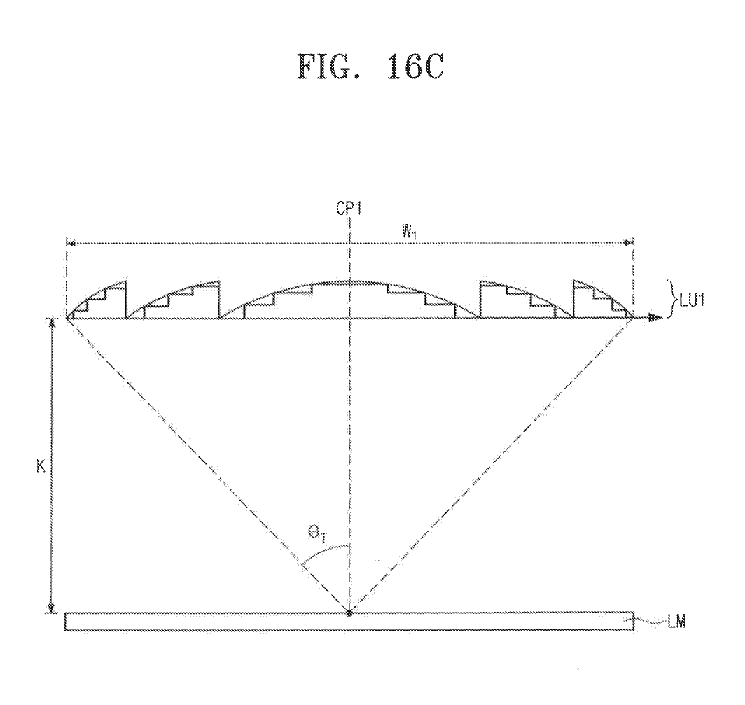

FIG. 16A is a view showing a path of the infrared light output from the display device according to an exemplary embodiment of the present invention, FIG. 16B is a graph showing the light detection efficiency of the display device shown in FIG. 16A according to an exemplary embodiment of the present invention, and FIG. 16C is a view showing a width and a focal length of a first lens unit according to a numerical aperture according to an exemplary embodiment of the present invention.

Referring to FIG. 16A, the first lens unit LU1 (refer to FIG. 12A) having the first inner focal point IP1 condenses the infrared light emitted from the optical member LM. To increase the light condensing efficiency, the first inner focal point IP1 of the first lens unit LU1 is defined in the diffusion sheet DFL (refer to FIG. 6).

FIG. 16B shows a simulated graph representing the efficiency of the amount of the light incident to the light sensor SN compared to the amount of the light exiting from the diffusion sheet DFL according to the numerical aperture NA of the first lens unit LU1, e.g., a coupling efficiency. Referring to FIG. 16B, when the first lens unit LU1 has the numerical aperture NA of about 0.3 or more, the amount of the light incident to the light sensor SN with respect to the amount of the light emitted from the diffusion sheet DFL is about 5% or more. In this case, the distance L between the input device TM and the diffusion sheet DFL is not he limited to a specific range. Therefore, the light sensor SN of the display device according to the present exemplary embodiment may sense the external input occurring at a long distance regardless of the distance L between the input device TM and the diffusion sheet DFL.

Hereinafter, the numerical aperture NA will be described in detail with reference to FIG. 16C. The numerical aperture NA is defined by the following Equation 1.

NA=sin(θ_{T}) <Equation 1>

In Equation 1, θ_{T} denotes a maximum incident angle of the first lens unit LU1. The maximum incident angle θ_{T} indicates an emission angle of the light incident to an edge of the first lens unit LU1 among the light emitted front the outer surface of the optical member LM, e.g., from the diffusion surface of the diffusion sheet DFL. The maximum incident angle θ_{T} is smaller than about 90 degrees.

A relationship between the width W₁ of the first lens unit LU1 and a first inner focal length K satisfies the following Equation 2.

W/2K=tan(θ_{T}) <Equation 2>

For instance, when θ_{T} is π/4, the width W₁ of the first lens unit LU1 may be two times larger than the first inner focal length K.

The distance control member LCM may control the first inner focal length K. In addition, the upper electrodes EPU may be designed in consideration of the first inner focal length K such that the first lens unit LU1 having a specific numerical aperture NA is formed.

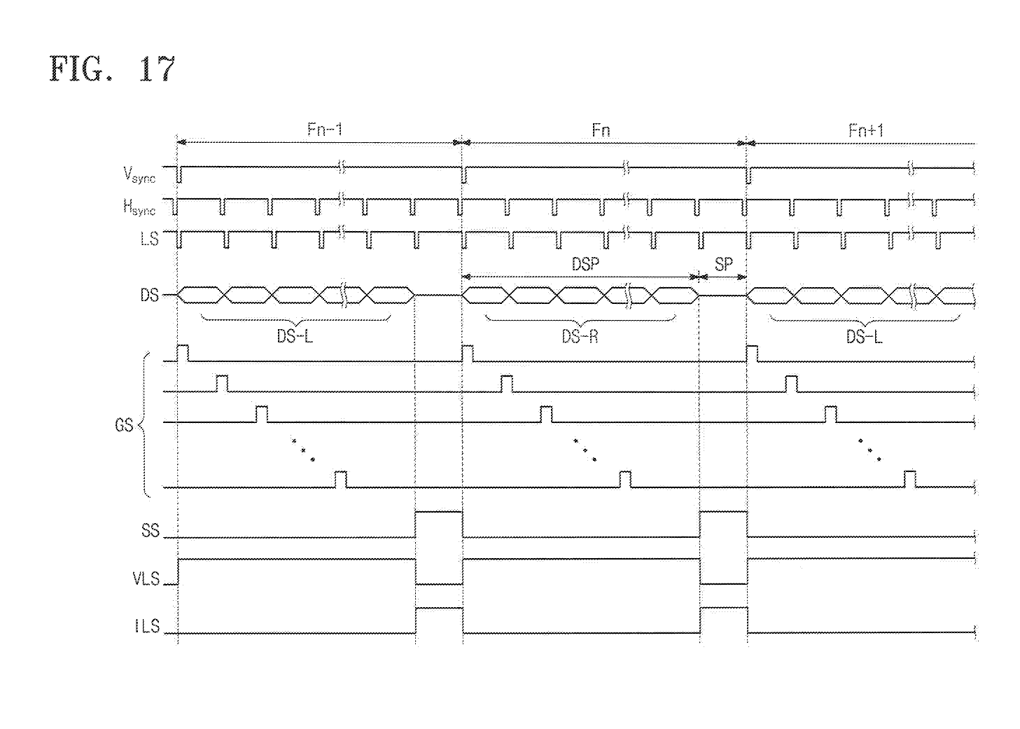

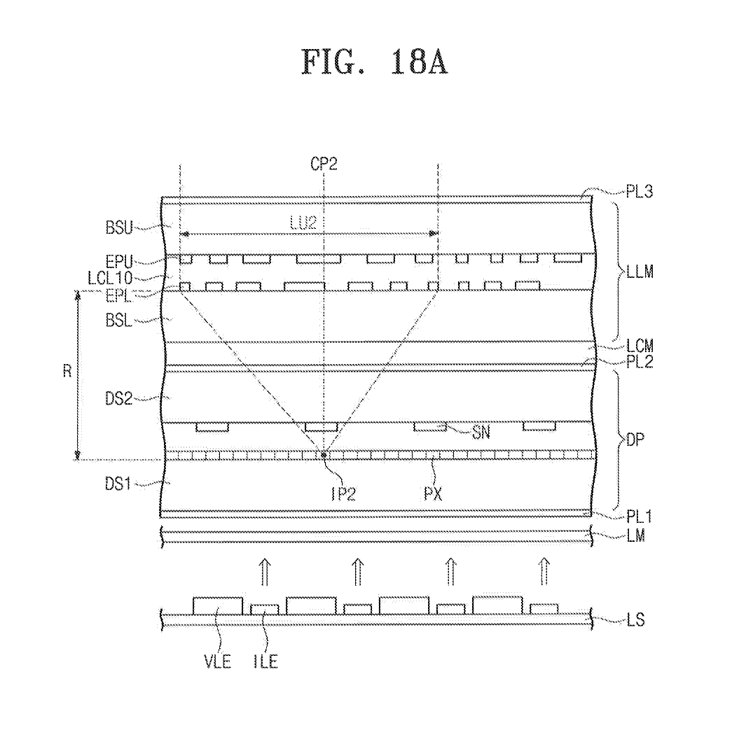

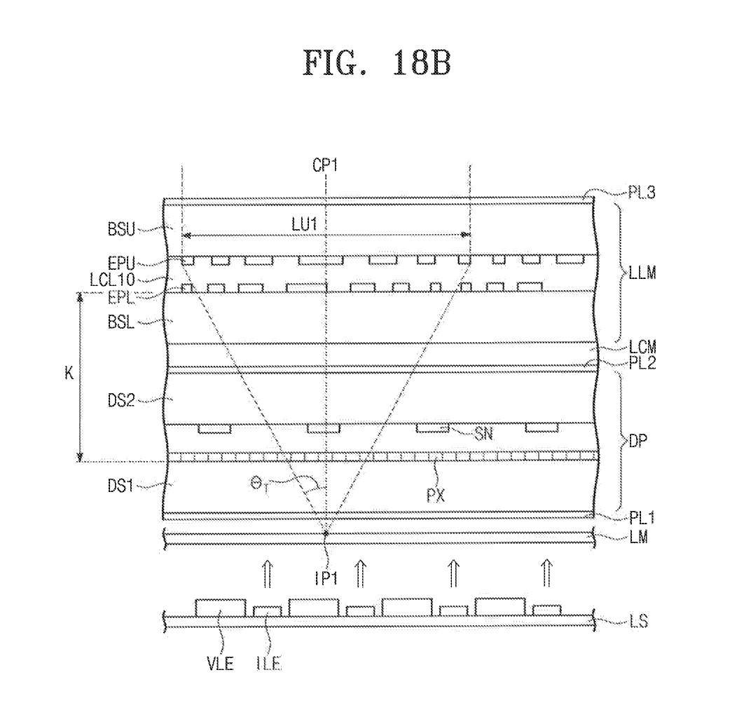

FIG. 17 is a timing diagram showing signals generated in the 3D mode display device according to an exemplary embodiment of the present invention, FIG. 18A is a cross-sectional view showing the display device operated in the display period of the 3D mode according to an exemplary embodiment of the present invention, and FIG. 18B is a cross-sectional view showing the display device operated in the detection period of the 3D mode according to an exemplary embodiment of the present invention.

Referring to FIG. 17, the display panel DP alternately displays a left-eye image and a right-eye image. Among the frame periods FRn−1, FRn, and FRn+1, the display panel DP displays the left-eye image during the (n−1)th frame period FRn−1 and displays the right-eye image during the n-th frame period FRn following the (n−1)th. frame period FRn−1. The left-eye image and the right-eye image may be displayed in each of the frame periods FRn−1, FRn, and FRn+1 through a high speed driving scheme.

The pixels PX receive left-eye data signals DS-L output during the display period DSP of the (n−1)th frame period FRn−1 and generate the left-eye image. The pixels PX receive right-eye data signals DS-R output during the display period DSP of the n-th frame period FRn and generate the right-eye image.

As shown in FIGS. 17 and 18A, the liquid crystal lens LLM forms the second lens unit LU2 (refer to FIG. 12B) during the display period DSP of the frame periods FRn−1, FRn, and FRn+1. The second lens unit LU2 has a second inner focal point IP2 defined on the pixels PX. A second inner focal length R of the second lens unit LU2 is shorter than the first inner focal length K of the first lens unit LU1.

The second lens unit LU2 provides the left-eye image and the right-eye image to an external focal point. To provide the high speed 3D image for the user, the second inner focal point IP2 is defined in the color filter CF (refer to FIG. 4).

The second lens unit LU2 that serves as a Fresnel zone plate lens may provide the left-eye image to a first external focal point and a second external focal point different from the first external focal point. The second lens unit LU2 separates the multi-viewpoint image into the external focal points using a diffraction phenomenon. The second lens unit LU2 may provide the right-eye image to a third external focal point and a fourth external focal point different from the third external focal point. The second lens unit LU2 provides the left-eye image and the right-eye image to the external focal points by taking left and right eye positions of the user who watches the display device and the number of users into consideration.

As shown in FIGS. 17 and 18B, the liquid crystal lens LLM forms the first lens unit LU1 during the detection period SP of the frame periods FRn−1, FRn, and FRn+1. The first lens unit LU1 is formed by the same method described with reference to FIGS. 13 and 14B.

As described above, the display device may sense the external input while displaying the 3D image. The first lens unit LU1 condenses the infrared light to the input device to increase the light detection efficiency of the light sensor SN. Thus, the light sensor SN may sense a non-touch input occurring at a long distance position.

According to the above, the first lens unit formed in the detection period condenses the infrared light exiting through the display panel to the input device disposed outside the display panel. In particular, when the first lens unit has the numerical aperture (NA) of about 0.3 or more, the light sensor receives the light having an amount higher than a critical value. Although the input device is disposed at a position far away from the display device, the light amount of the infrared light applied to the light sensor after being reflected by the input device is higher than the critical value. Thus, the long distance input caused by the user is not limited to a specific range.

Although the present invention has been shown and described with reference to exemplary embodiments thereof, it is understood by those of ordinary skill in the art that various changes in form and detail can be made thereto without departing from the spirit and scope of the present invention as hereinafter claimed.

What is claimed is:

1. A display device, comprising:
a light source that emits a visible light and a detection light having a wavelength range different from a wavelength range of the visible light;
an optical member disposed on the light source;
a display panel disposed on the optical member and including a pixel configured to receive the visible light to generate an image;
a liquid crystal lens that includes a liquid crystal layer and first electrodes, wherein the first electrodes form a first lens unit, the first lens unit having a first focal point located in the optical member to condense the detection light exiting from the display panel to an input device disposed outside the display panel; and
a light sensor that receives the detection light reflected by the input device to sense an external input.

2. The display device of claim 1, wherein the first lens unit has a numerical aperture of about 0.3 or more and the numerical aperture satisfies the following equation, NA=sin(θ_{T}), where θ_{T} is a maximum incident angle of the first lens unit and is smaller than about 90 degrees, and NA denotes the numerical aperture.

3. The display device of claim 2, wherein the first lens unit has a width and a first focal length, and the width and the first focal length satisfy the following equation, W/2K=tan(θ_{T}), where W denotes the width and K denotes the first focal length.

4. The display device of claim 3, wherein the optical member comprises a prism sheet and a diffusion sheet disposed on the prism sheet, and the first focal point is located on a diffusion surface of the diffusion sheet.

5. The display device of claim 1, wherein the liquid crystal lens further comprises second electrodes that form a second lens unit having a second focal point located in the pixel.

6. The display device of claim 5, wherein the first electrodes are spaced apart from the second electrodes and the liquid crystal layer is disposed between the first electrodes and the second electrodes.

7. The display device of claim 5, wherein the pixel comprises:
a liquid crystal capacitor;
a thin film transistor that applies a pixel voltage to the liquid crystal capacitor; and
a color filter overlapped with the liquid crystal capacitor.

8. The display device of claim 7, wherein the second focal point is located in the color filter.

9. The display device of claim 8, wherein each of the first and second lens units is a Fresnel zone plate lens.

10. The display device of claim 1, wherein the light sensor comprises a photo-transistor configured to generate a photocurrent corresponding to an amount of the received detection light.

11. A display device, comprising:
a light source that emits a visible light in display periods and an infrared light in detection periods;
an optical member disposed on the light source;
a display panel disposed on the optical member and configured to generate a two-dimensional image in a two-dimensional mode display period of the display periods and a three-dimensional image in a three-dimensional mode display period of the display periods;
a light sensor disposed on the optical member and configured to receive a portion of the infrared light reflected by an input device to sense an external input; and
a liquid crystal lens that includes a liquid crystal layer, first electrodes and second electrodes, wherein the first electrodes form a first lens unit having a first focal point located in the optical member, and the second electrodes form a second lens unit having a second focal point located in the display panel.

12. The display device of claim 11, wherein the first electrodes are spaced apart from the second electrodes and the liquid crystal layer is disposed between the first electrodes and the second electrodes.

13. The display device of claim 12, wherein the first electrodes have a same electric potential as the second electrodes during the two-dimensional mode display period.

14. The display device of claim 11, wherein the optical member comprises a prism sheet and a diffusion sheet disposed on the prism sheet, and the first focal point is located on a diffusion surface of the diffusion sheet.

15. The display device of claim 14, wherein the display panel comprises:
a first substrate;
a second substrate spaced apart from the first substrate; and
a plurality of pixels disposed between the first and second substrates, and at least one of the pixels comprises:
a liquid crystal capacitor;
a thin film transistor that applies a pixel voltage to the liquid crystal capacitor; and
a color filter overlapped with the liquid crystal capacitor.

16. The display device of claim 15, wherein the second focal point is located in the color filter.

17. The display device of claim 14, wherein the light sensor comprises a photo transistor configured to generate a photocurrent corresponding to an amount of the received detection light.

18. The display device of claim 17, wherein the photo-transistor is disposed on the first substrate.

19. The display device of claim 11, wherein each of the first and second lens units is a Fresnel zone plate lens.

20. The display device of claim 19, wherein the first lens unit has a numerical aperture of about 0.3 or more and the numerical aperture satisfies the following equation, NA=sin(θ_{T}), where θ_{T} is a maximum incident angle of the first lens unit and is smaller than about 90 degrees, and NA denotes the numerical aperture.
